(19) United States
(12) Patent Application Publication
(10) Pub. No.: US 2017/0223302 A1
(43) Pub. Date: Aug. 3, 2017

(54) CRITICAL INCIDENT SOLUTION

(71) Applicants: Roger Conlan, NEW YORK, NY (US); Daniel J. O'Kane, Tomkins Cove, NY (US)

(72) Inventors: Roger Conlan, NEW YORK, NY (US); Daniel J. O'Kane, Tomkins Cove, NY (US)

(21) Appl. No.: 15/014,389

(22) Filed: Feb. 3, 2016

(51) Int. Cl. H04N 5/445; H04N 9/80; G08B 13/196; H04N 7/18

(52) U.S. Cl. CPC H04N 5/44504; H04N 7/181; H04N 9/80; G08B 13/19695

(57) ABSTRACT

A critical incident solution includes a video capturing system includes at least one video camera located at a monitored location. The video cameras capture a video scene and generate a video feed for display of the video scene. The video scene includes images of a critical incident. A video reviewing system that includes at least one video monitor is located at a monitoring location. A communications system transmits the video feed from the video capturing system to the video reviewing system. A content composing system composes enhanced content pertaining to the critical incident. An activatable alert switch causes the video capturing system to remotely signal the video reviewing system over the communications system to indicate the occurrence of the critical incident. A wireless communication system receives the composed enhanced content and transmits the enhanced content to at least one remote mobile display. The mobile display displays the enhanced content to a responding personnel.

### CROSS REFERENCE TO RELATED APPLICATIONS

This is the US Utility application of U.S. Provisional application Ser. No. 62/112,249, filed on Feb. 5, 2015, which is herein incorporated by reference in its entirety.

### TECHNICAL FIELD

The present invention relates to a method, apparatus and system for monitoring a monitored location, receiving at a monitoring location an alert triggered by an critical incident event at the monitoring location, and providing enhanced content to remotely located responders prior to entering and while on premises at the monitored location during the response to the critical incident.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section.

It is an unfortunate reality of modern life that critical incidents occur in public and private spaces. The critical incident may be, for example, a gunman entering a school, or a hostage situation at a bank.

Many public and private spaces are equipped with security cameras. Providing a live video feed and other incident-related information to responders, such as police, fire, military or security services would greatly benefit the critical initial actions of such responders.

Often these security cameras record the critical incident as it unfolds, such as a hostage situation, that is recorded by the security cameras while the situation is in progress. However, even though the proliferation of these security cameras results in the recording of the critical incident, sometimes from many angles and locations within the space, previous attempts at making use of the video from these cameras are typically an after-the-fact part of the gathering of forensic evidence from a now-past critical incident.

### SUMMARY OF THE INVENTION

This section is intended to include examples and is not intended to be limiting. The present invention is intended to overcome the drawbacks of previous attempts. In accordance with the inventive critical incident system a video capturing system is provided. The video capturing system includes at least one video camera located at a monitored location. Each video camera captures a video scene and generates a video feed for the display of the video scene. The video scene includes images of a critical incident. A video reviewing system comprising at least one video monitor is located at a monitoring location. A communications system transmits the video feed from the video capturing system to the video reviewing system.

In accordance with an aspect of the inventive critical incident system, a method includes capturing a video scene and generating a video feed containing the video scene using a video capturing system. The video capturing system includes at least one video camera located at a monitored location, such as a school. Each video camera captures the video scene and generates the video feed for the display of the video scene. The video scene includes images of a critical incident. The video feed is transmitted to a video reviewing system that includes at least one video monitor located at a monitoring location, such as a police station. The video feed is transmitted over a communications system 26 for transmitting the video feed from the video capturing system to the video reviewing system.

In accordance with another aspect of the inventive critical incident system, a method includes receiving a video feed containing a captured video scene. The video scene is captured using a video capturing system comprising at least one video camera located at a monitored location, such as a bank. Each video camera captures the video scene and generates the video feed for the display of the video scene. The video scene includes images of a critical incident. The video feed is received by a video reviewing system comprising at least one video monitor located at a monitoring location, such as a police station. The video feed is transmitted over a communications system for transmitting the video feed from the video capturing system to the video reviewing system.

In accordance with still another aspect of the inventive critical incident system, an apparatus, comprises one or more processors, and one or more memories including computer program code. The one or more memories and the computer program code are configured, with the one or more processors, to cause the apparatus to capture a video scene and generate a video feed containing the video scene using a video capturing system comprising at least one video camera located at a monitored location. Each video camera captures the video scene and generates the video feed for display of the video scene. The video scene includes images of a critical incident. The video feed is transmitted to a video reviewing system comprising at least one video monitor located at a monitoring location. The video feed is transmitted over a communications system for transmitting the video feed from the video capturing system to the video reviewing system.

In accordance with still another aspect of the inventive critical incident system, a video capturing system includes at least one video camera located at a monitored location. The video cameras capture a video scene and generate a video feed for display of the video scene. The video scene includes images of a critical incident, for example, images at a school after an intruder has entered. A video reviewing system that includes at least one video monitor is located at a monitoring location. A communications system transmits the video feed from the video capturing system to the video reviewing system. A content composing system, which may be located at the monitoring location or another location, composes enhanced content pertaining to the critical incident from sources including at least from the video feed. An activatable alert switch causes the video capturing system to remotely signal the video reviewing system over the communications system to indicate the occurrence of the critical incident. A wireless communication system receives the composed enhanced content and transmits the enhanced content to at least one remote mobile display. The mobile display displays the enhanced content to a responding personnel responding to the monitored location in response to the occurrence of the critical incident.

### BRIEF DESCRIPTION OF THE DRAWINGS

FIG. 1 is a schematic illustration showing components of a non-limiting, exemplary embodiment of the inventive critical incident system;

FIG. 2 is an illustration showing components of a non-limiting, exemplary embodiment of the inventive critical incident system;

FIG. 3 is an illustration showing components of a non-limiting, exemplary embodiment of the inventive critical incident system;

FIG. 4 illustrates hardware installed at a monitored location in accordance with a non-limiting, exemplary embodiment;

FIG. 5 illustrates hardware installed at a monitoring location in accordance with a non-limiting, exemplary embodiment;

FIG. 6 illustrates responders arriving at a monitored location during a critical incident;

FIG. 7 illustrates a smartphone used by a responder display enhanced content related to a critical incident;

FIG. 8 illustrates a laptop computer or pad display device displaying enhanced content related to a critical incident;

FIG. 9 is a schematic illustration showing components of another non-limiting, exemplary embodiment of the inventive critical incident system; and

FIG. 10 illustrates video monitor displaying content available for composing an enhanced content display screen.

### DETAILED DESCRIPTION OF THE INVENTION

The word “exemplary” is used herein to mean “severing as an example, instance, or illustration” Any embodiment described here as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The exemplary embodiments herein describe techniques for monitoring a critical incident. Additional description of these techniques is presented after a system into which the exemplary embodiments may be used is described.

The inventive critical incident system is embodied as a method, apparatus and system for monitoring a monitored location, receiving at a monitoring location an alert triggered by an event at the monitoring location, and providing enhanced content to remotely located responders prior to entering and while on premises at the monitored location during a critical incident.

The inventive critical incident system is for installation in and monitoring of public and private spaces, such as schools, hotels, stadiums, libraries, office buildings, warehouses, airport and other transportation stations, courthouses, and other public or private venues.

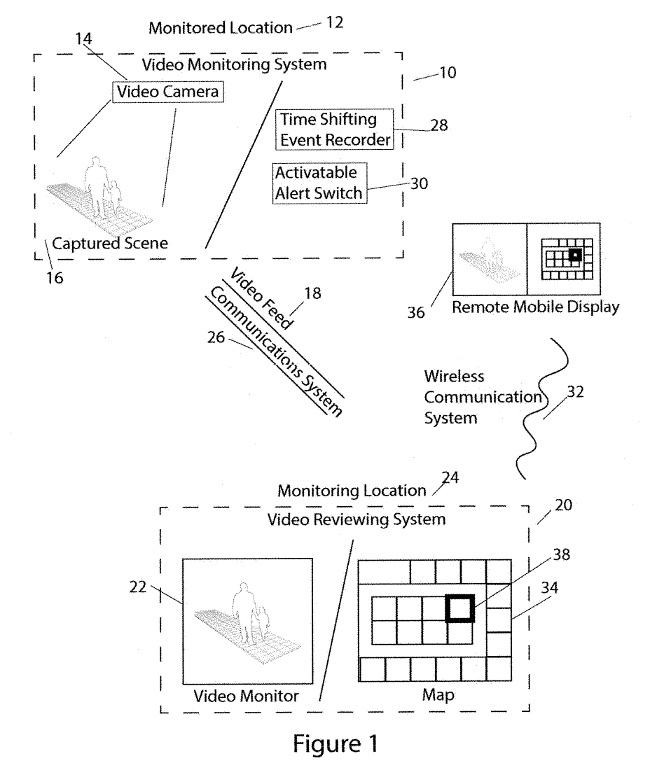

FIG. 1 is a schematic illustration showing components of a non-limiting, exemplary embodiment of the inventive critical incident system. In accordance with the inventive critical incident system a video capturing system 10 is provided. The video capturing system 10 includes at least one video camera 14 located at a monitored location 12. Each video camera 14 captures a video scene 16 and generates a video feed 18 for the display of the video scene 16. The video scene 16 includes images of a critical incident. A video reviewing system 20 comprising at least one video monitor 22 is located at a monitoring location 24. A communications system 26 transmits the video feed 18 from the video capturing system 10 to the video reviewing system 20.

In accordance with a non-limiting embodiment of the invention, at least one of the video capturing system 10 and the video reviewing system 20 includes a time shifting event recorder 28, e.g., a digital video recorder or network video recorder (DVR/NVR) for recording the video feed 18 from at least one of said at least one video camera 14 for viewing of the recorded video feed 18 during the occurrence of the critical incident in a time shifted manner.

An activatable alert switch 30 maybe provided for causing the video capturing system 10 to remotely signal the video reviewing system 20 over the communications system 26 to indicate the occurrence of the critical incident. The activatable alert switch 30 may be a user-activated panic button. Alternatively, the activatable alert switch 30 may be a sound triggered transducer for triggering an alert in response to a detected noise having a predetermined characteristic, such as exceeding a predetermined decibel level or having a sound signature consistent with a threat, such as a gunshot. The activatable alert may be obtained from other installed systems, such as a security system that detects a break in at an entry way or window. The activable alert may cause the video capturing system 10 to remotely signal the video reviewing system 20 to display a map 34 of the monitored location 12 showing the location 38 of the critical incident to be displayed at the monitoring location 24.

A wireless communication system 32 may be provided for transmitting at least one of the video feed 18 and the map 34 of the monitored location 12 to a least one remote mobile display 36. The least one remote mobile display 36 may be associated with a police, military, or security personnel responding to the monitored location 12 in response to the occurrence of the critical incident. For example, a responding police officer may receive, via the wireless communication system 32, at least one of the video feed 18, the time shifted video and the map 34. The responding police officer is thus given direct knowledge of the critical incident before entering the monitored location 12 where the critical incident is or has occurred. The knowledge obtained through the use of the inventive critical incident system can include dress, number, physical characteristics, weapons carried of the perpetrators of the critical incident, as well as the precise whereabouts within the monitored location 12 of the perpetrators, hostages, other responding personnel, ingress and egress pathways, etc.

The wireless communication system 32 is associated with at least one of the video capturing system 10 and the video reviewing system 20. For example, once the responding officer is on-scene, the video feed 18 may be obtained directly by accessing a wireless signal transmitted from the video capturing system 10, or the information may be accessed from a wireless signal transmitted from the monitoring location 24. The communications system 26 may be a dedicated Internet connection between the monitored location 12 and the monitoring location 24. For example, a virtual private network, or an otherwise more secure and possibly more direct communications link can be provided between the monitored location 12 and the monitoring location 24.

In accordance with an aspect of the inventive critical incident system, a method includes capturing a video scene 16 and generating a video feed 18 containing the video feed 18 using a video capturing system 10 comprising at least one video camera 14 located at a monitored location 12. Each video camera 14 captures the video scene 16 and generates the video feed 18 for the display of the video scene 16. The video scene 16 includes images of a critical incident. The video feed 18 is transmitted to a video reviewing system 20 comprising at least one video monitor 22 located at a monitoring location 24. The video feed 18 is transmitted over a communications system 26 for transmitting the video feed 18 from the video capturing system 10 to the video reviewing system 20.

In accordance with another aspect of the inventive critical incident system, a method includes receiving a video feed 18 containing a captured video scene 16. The video scene 16 is captured using a video capturing system 10 comprising at least one video camera 14 located at a monitored location 12. Each video camera 14 captures the video scene 16 and generates the video feed 18 for the display of the video scene 16. The video scene 16 includes images of a critical incident. The video feed 18 is received by a video reviewing system 20 comprising at least one video monitor 22 located at a monitoring location 24. The video feed 18 is transmitted over a communications system 26 for transmitting the video feed 18 from the video capturing system 10 to the video reviewing system 20. At the monitoring location, when an alert is triggered, pre-stored maps of the location of cameras may be provided. For example, the maps of the locations of cameras may include cameras located at multiple floors and multiple buildings including multiple sites.

In accordance with still another aspect of the inventive critical incident system, an apparatus, comprises one or more processors, and one or more memories including computer program code. The one or more memories and the computer program code are configured, with the one or more processors, to cause the apparatus to capture a video scene 16 and generate a video feed 18 containing the video scene 16 using a video capturing system 10 comprising at least one video camera 14 located at a monitored location 12. Each video camera 14 captures the video scene 16 and generates the video feed 18 for display of the video scene 16. The video scene 16 includes images of a critical incident. The video feed 18 is transmitted to a video reviewing system 20 comprising at least one video monitor 22 located at a monitoring location 24. The video feed 18 is transmitted over a communications system 26 for transmitting the video feed 18 from the video capturing system 10 to the video reviewing system 20.

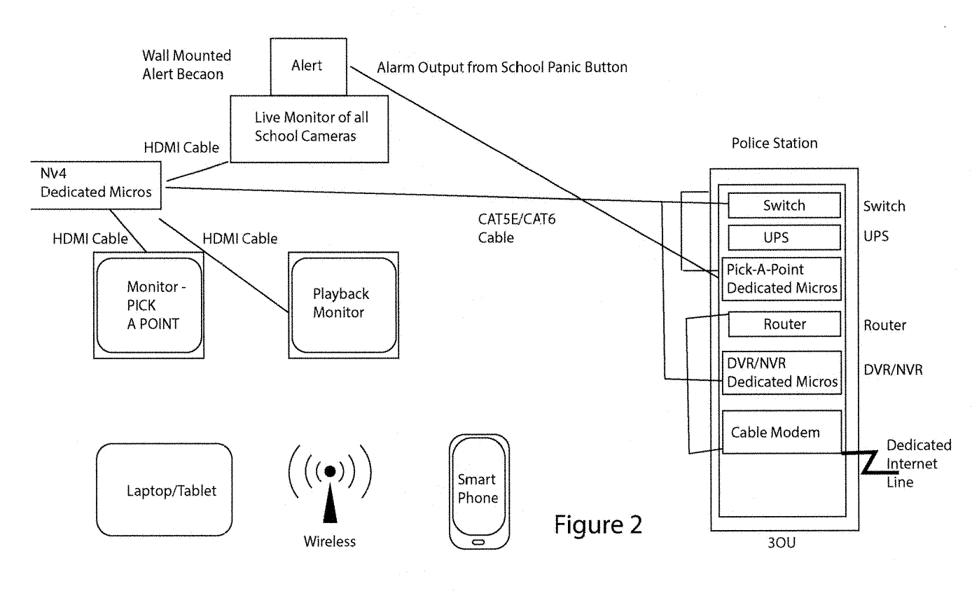

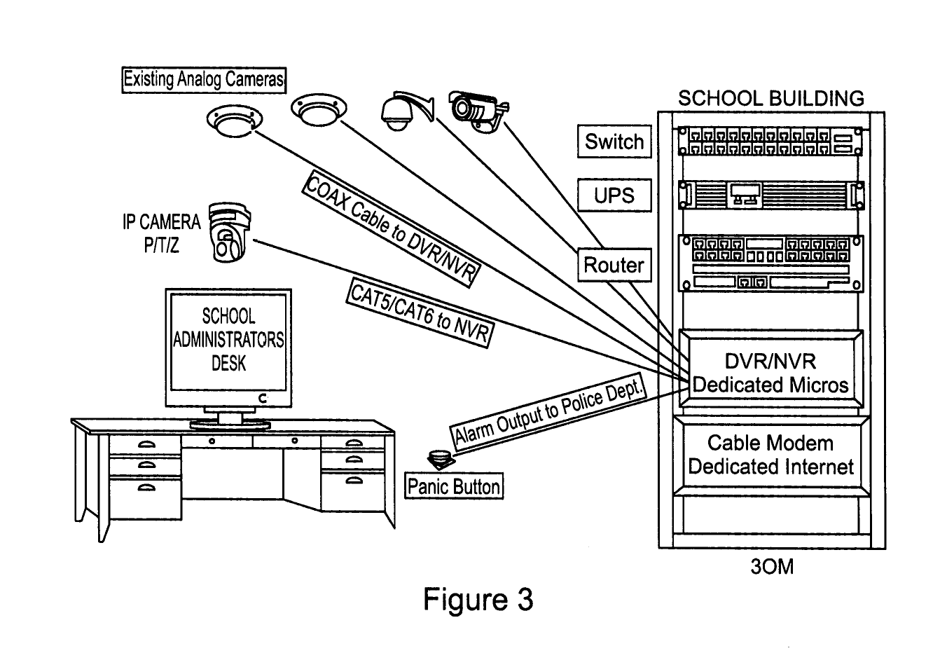

FIG. 2 is an illustration showing components of a non-limiting, exemplary embodiment of the inventive critical incident system, and FIG. 3 is an illustration showing components of a non-limiting, exemplary embodiment of the inventive critical incident system.

In accordance with a non-limiting exemplary embodiment, the inventive critical incident system provides for the viewing of security cameras 14 for authorized personnel, such as, for example, a local police department in the event of a critical incident. Cameras 14 located throughout the monitored location 12 enable viewing of live activity, and, in accordance with a non-limiting exemplary embodiment, in addition to viewing a live feed from the installed cameras 14, the inventive critical incident system enables the authorized personnel to review video that has been captured prior to, or during the unfolding of, the incident. As an example, in accordance with the inventive critical incident system, a local police department, including police personnel located at the department offices as well as mobile police officers responding to the scene, is provide with information of a current situation that put a school in lock down. The inventive critical incident system can be used to provide, for example, the responding police officers, and remotely located command and control units, with information of the current situation prior to entry to the building. In accordance with this exemplary utilization of the inventive critical incident system, police cars may be equipped with the ability to receive live video to be viewed by the responding police officer while in transit to the school. A dedicated internet or other communication line is installed at the police station as well as the school to create a separate secured network for viewing video.

In order to determine the infrastructure necessary for implementation of the inventive critical incident system, a number of assessments and reviews are performed to determine the readiness and added equipment and training needed for implementation of the inventive critical incident system. The assessments and reviews include, for example, some or all of the following non-limiting examples. An evaluation is made of any current information technology infrastructure, such as wiring, routers and switches, that are already installed and in use at the monitored location 12 (e.g., a school) and the monitoring location 24 (e.g., a police department). The evaluation includes for example, but is not limited to, the manufacturer of the current cameras, digital video recording device(s) and/or network video recording device(s), if any are pre-existing.

An evaluation is made of any of the monitored location's 12 vulnerabilities or advantages, including cameral location placement, quality, age, features and operational suitability, along with the location, quality, features and operational suitability of any digital video recording device(s) and/or network video recording device(s). An assessment is made of any areas of possible entry that are vulnerable without current coverage. A review may be made with a safety team at each school, including the procedures for entering lock down. Co-ordination is made, as necessary with any vendor currently under contract for security cameras, etc. A review is done with the information technology staff at the monitored location 12 (e.g., school) and monitoring location 24 (e.g., police department) to review infrastructure of the wireless access network and local area network for communication link between the monitored location(s) 12 and monitoring location(s) 24 WAN/LAN. A review is done of workstation and monitor equipment needed for deployment of the inventive critical incident system. Once the assessments and reviews are performed, a monitored location 12 assessment plan is prepared for deployment of the inventive critical incident system.

In accordance with the inventive critical incident system, at each monitored location 12 (e.g., school), at least one DVR/NVR is installed and connected to monitoring cameras. Each monitored location 12 will also have one or more panic buttons installed, and as necessary, a communication system, such as a dedicated internet line, is installed for communication between the monitored location 12 and the monitoring location 24.

At the monitoring location 24 (e.g., police station) the inventive critical incident system hardware/software system is installed and connected to the dedicated internet line. The hardware/software system is wired to an NVR which connects to existing or newly installed monitors at the monitoring location 24. An alarm sounder with light may be installed, for example, next to a main monitor 22 that shows the video feed 18 from the cameras 14 at the monitoring location 24 so that, if a critical incident occurs at the monitoring location 24, it can be viewed from the displayed video feed 18 at the monitoring location 24 in real time as the incident is occurring. In the event of an emergency, a panic button can be provided so that a staff member or other person at the monitored location 12 (e.g., the school) can push the panic button and automatically enable live viewing of all cameras 14 in that school at the police station. At the police station, once the panic button is pushed at one of the monitored schools, a map 34 of that school may also be displayed (for example, on a different monitor) showing a diagram of where the cameras 14 are installed for that school. To avoid any potential loss of time or the ability to obtain critical information, the inventive critical incident system can be set up so that no login procedure is necessary for the police to access live viewing of the school's cameras. The police can then deploy live video out to patrol cars that are in transit to the school requiring help.

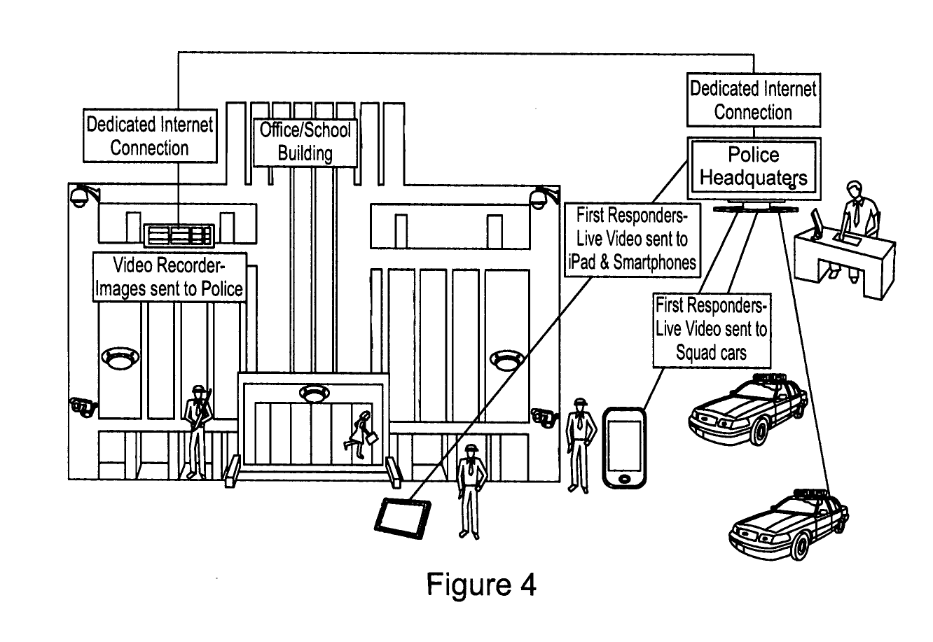

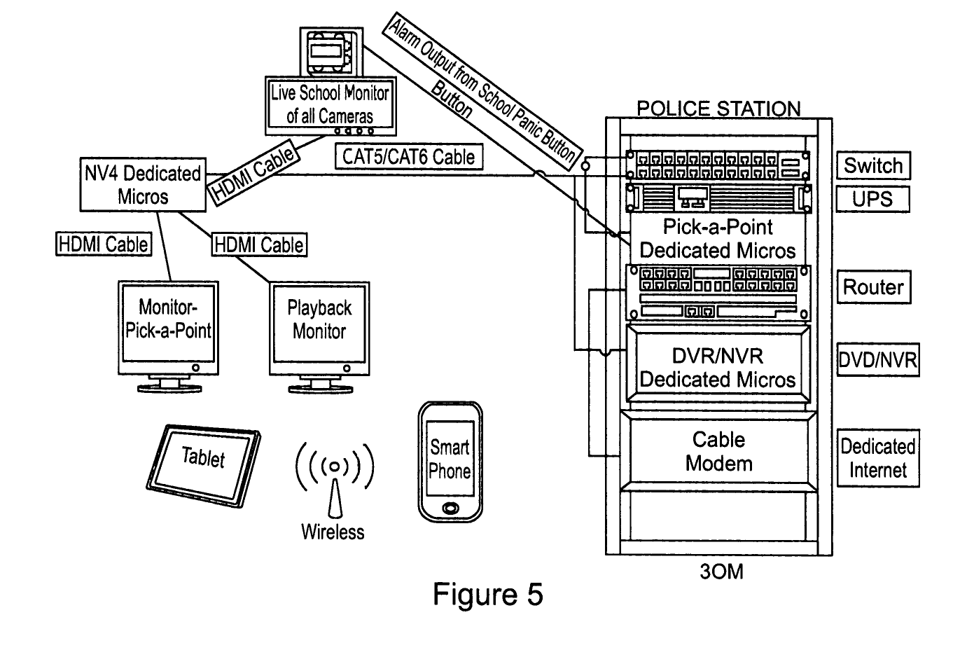

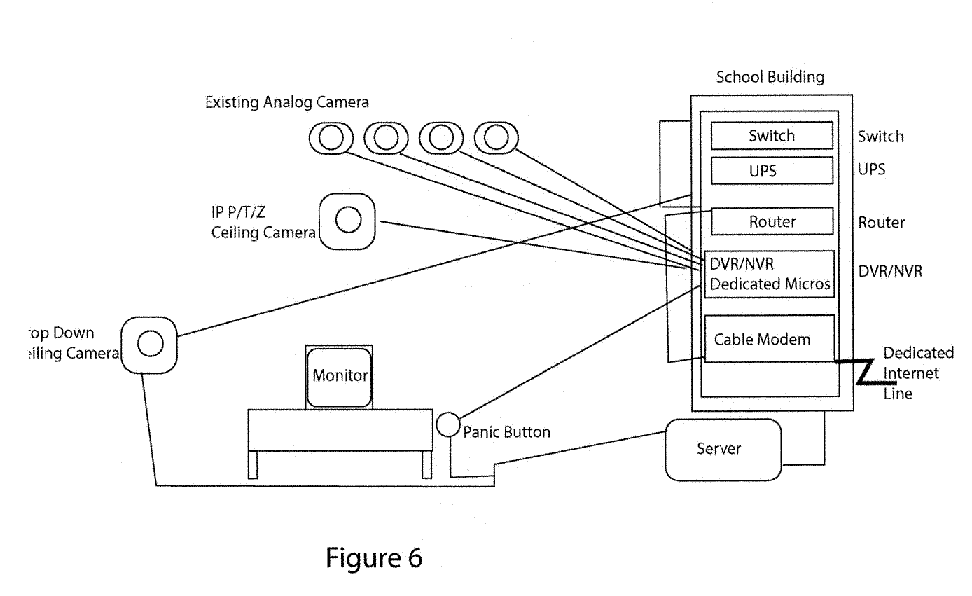

The constituent parts of an exemplary embodiment are described with reference to FIGS. 4-6. FIG. 4 illustrates hardware installed at a monitored location 12 in accordance with a non-limiting, exemplary embodiment. FIG. 5 illustrates hardware installed at a monitoring location 24 in accordance with a non-limiting, exemplary embodiment. FIG. 6 illustrates responders arriving at a monitored location 12 during a critical incident.

In accordance with an exemplary embodiment, software and hardware devices are installed at a monitored location 12, (e.g., a school, theme park, church, sport stadium, theater, residence or business) to enable viewing of existing security surveillance cameras at a monitoring location 24, (e.g., a police station, private security company, business owner's home or central office) over a dedicated Internet, VPN, closed circuit, wired/wireless, or other network connection. The monitoring location 24 has the ability to view live streaming video and audio, as well as time-shifted replay of prior video even immediately prior to the alert of the critical incident (recorded, buffered) and during an ongoing emergency. Enhanced information of a current situation occurring at that site in an emergency situation such as a site in a lock down state, is provided remotely from the monitoring location 24. For example, the enhance information may be composed by trained personnel at the monitoring location 24 and/or composed by an artificial intelligent agent at a cloud-based server 40 or created automatically at the monitored location 12. The enhanced information may be transmitted over a wireless and/or wireless network connection. The enhanced information may be, for example, details about the intruders including number, approximate height, clothing, hair color, gender, etc., a map of the monitored location with “moving targets” displayed such as movement of the intruders and the like. The enhanced information can be provided prior to and concurrent with responders entering and/or being at the location of the emergency (e.g., the monitored location 12).

Responding personnel (responders) may carry devices, such as smart phones, PDAs, radio transceivers, and other communication devices. Transportation equipment, such as police cars, helicopters, etc., may be equipped to view live video provided as the responders are in transit to the monitored location 12.

The responders may wirelessly view live and/or time shifted video on display devices such as smart phones, tablets or laptops. A dedicated internet line may be provided to create a separate secured network connection between the monitored and the monitoring location 24. In accordance with the exemplary embodiment, the network connection may be compatible with one or more emergency, municipal, government and/or private networks, such as First Net.

In accordance with an exemplary implementation of the inventive critical incident solution, a method includes capturing a video scene 16 and generating a video feed 18 containing the video scene 16 using a video capturing system 10. The video capturing system 10 includes at least one video camera 14 located at a monitored location 12, such as a school. Each video camera 14 captures a video scene 16 and generates the video feed 18 for the display of the video scene 16. The video scene 16 includes images of a critical incident. The video feed 18 is transmitted to a video reviewing system 20 that includes at least one video monitor 22 located at a monitoring location 24, such as a police station. The video feed 18 is transmitted over a communication system 26 for transmitting the video feed 18 from the video capturing system 10 to the video reviewing system 20.

At least one of the video capturing system 10 and the video reviewing system 20 may include a time shifting event recorder 28 for recording the video feed 18 from at least one of said at least one video camera 14 for viewing of the recorded video feed 18 during the occurrence of the critical incident in a time shifted manner.

An activatable alert switch 30 (e.g. panic button) causes the video capturing system 10 at the monitored location 12 to remotely signal the video reviewing system 20 at the monitoring station over the communication system 26 to indicate the occurrence of the critical incident.

The activatable alert switch 30 can also or alliteratively be a sound triggered transducer for triggering an alert in response to a detected noise having a predetermined characteristic, such as exceeding a predetermined decibel level or having a sound signature consistent with a threat, such as a gunshot, shattering glass. Additional examples of triggering mechanisms can be and are not limited to, pulling of the fire alarms, gun shots, loud crashing sounds, motion sensors, etc. The triggering mechanism can fully integrate with any other triggering systems as well as 911 calls and manual triggering.

The activatable alert may cause the video capturing system 10 to remotely signal the video reviewing system 20 to show a map 34 of the monitored location 12 showing the precise location of the critical incident displayed at the monitoring location 24. The map 34 may contain enhanced information such as number of people expected to be present (e.g., classroom count), number of people currently present (e.g., using pattern recognition software and hardware solutions to count the individuals). For example, the pattern recognition software could be used to detect and track an unknown or unexpected individual(s) from video information obtained by various security cameras, with the map 34 enhanced to show current and previous locations of the tracked individuals. The tracking may include computer program code for reviewing and comparing time shifted video from “always on” video cameras 14, such as those recording doorways and parking lots with live video from “activatable” video cameras 14, such as a drop down camera installed in a classroom.

In accordance with this aspect, events that happened prior to the triggering of the alert are available for adding enhancements to the information conveyed to viewers at the monitored location 12 (e.g., other classrooms), the monitoring location 24 (e.g., the police department), and responders (e.g., the police officers, firemen and ambulance). When an alert is triggered the computer program code stored in a memory and running on a microprocessor has data available from the always on video cameras 14 to obtain useful information, such as entry points, number of individuals entering, materials, weapons, etc. The computer program code may be located, for example, at one or more of the monitored location 12, cloud-based server 40, monitoring location 24, and the responders. The monitoring location 24 may be, for example, private security firm, police station and other municipal building, and have on staff trained personnel who can create enhanced information content screens made available to convey real-time relevant information composed from time shifted and real-time video, audio and other data feeds.

A wireless communication system 32 transmits the enhanced information (e.g., an enhanced information contact screen with a live and/or time shifted video feed 18, and/or the map 34 of the monitoring location 24) to a least one remote mobile display 36 viewable by a responder, such as a responding police officer.

The communication system 26 may be a dedicated Internet connection between the monitored location 12 and the monitoring location 24, such as the First Responder Network Authority (First Net, https://en.wikipedia.org/wiki/First_Responder_Network_Authority). The communication system can be over a VPN, utilize encryption of some or all data, and be compatible with local, state, federal, international and private networking systems.

As shown in FIG. 4, at a monitored location 12 new hardware is installed and connected to the current camera system. Each monitored location 12 will also have several options of panic devices installed. Triggering devices and events can be panic buttons, IP phones, Smart Boards, fire alarms, motion sensors, loud audible sounds, video and/or sound analytics or a Critical Incident App installed on smart phones. The Critical Incident App may be run, for example, on a smart phone, computer or personal display device. In the case of a hand held device, such as a smart phone, the Critical Incident App may enable mobile and instant access to information or provide a source of information. For example, the Critical Incident App may be activated by a dedicated short cut (screen icon), smartphone button or screen swipe. Once activated, a pulsed vibration having a predetermined pattern can silently confirm the triggering of an alert, instigating actions, such as turning on of cameras, alerts to school office and police station, etc., which sets in motion the hardware and software solutions described herein.

As shown in FIG. 5, at the monitoring location 24, in accordance with an exemplary embodiment, new hardware may be installed and connected to a dedicated internet line and connected to the monitored location 12. The monitoring location 24 will have several monitors wired to a network switch. An alarm sounder with strobe light may be installed in close proximity to the main video monitor 22 that shows the cameras at the site where there is a Critical Incident occurring. In the event of an emergency the site can trigger many different alert devices such as; the dialing of an IP phone, pulling of a fire alarm, a loud audible alert device, motion sensor, panic button, video analytics, smart board or the Critical Incident App on a smart phone or tablets.

During a Critical Incident, the monitored location 12 and the monitoring location 24 become linked for remote access to devices installed at the monitored location 12 by the monitoring location 24 (or mobile responder unit). For example, if any of the trigger options are deployed, power is sent to drop down ceiling camera(s) and to turn on the IP cameras in the classrooms/site. Otherwise, the cameras may be left non-operational and/or not visible (to overcome resistance to privacy concerns by teachers and staff). The video from the cameras may be able to be viewed in live and replay mode. If an emergency is called in from the site and was not triggered by a panic device, police or other authorized responders will have the ability to remotely trigger the power to the drop down ceiling cameras and power them on. This may also open the port on a router to allow streaming live video and audio to cameras that are equipped with that option back to the police station or any monitoring station. This will automatically enable live viewing of all cameras in that site where Critical Incident has been installed. At the police station/monitoring station, once one of the panic devices are activated at one of the sites, a map 34 of the site may also be displayed on the same or on a separate monitor 22 showing a map 34 of the building design diagram of where the cameras are installed for that site. An alarm may sound at the police/monitoring station and live video of the sites cameras will be automatically displayed on the monitor 22 installed at the police station. In accordance with an exemplary embodiment, no software login procedure is necessary for police to access live viewing of the sites cameras. The monitoring station is able to watch live video as well as replay video simultaneously. Police can then deploy live video out to patrol cars that are in transit to the site requiring assistance. A touch screen monitor 22 may be provided to show the map 34 of the site with the pictures and location of all cameras at the site. The onscreen icon of the camera can be pressed to view that camera live.

A generator connecting all devices may be in place in the event of losing power. A back up cellular internet access may also be installed at the site and at the police/monitoring station. In the event of internet failure this will provide backup internet access to enable the ability to streaming live video from that site.

As shown in FIG. 6, first responders are able to see live video of the critical incident as it is occurring. Multiple users may be able to view images at the same time. Images can be of all the cameras or individual cameras. Police at headquarters can send the images directly to the squad car while they are in transit to the scene. Once a panic device is triggered it opens the live feed to the site of the critical incident. All cameras are available in the event that there are multiple suspects or incidents occurring simultaneously. Police staff at the monitoring station can compose an enhanced information feed that is transmitted to the first responders. The enhanced information feed can include split screen details including, but not limited to, a map 34 of the monitored location 12 showing features such as perpetrator location, entry point, known hostages or casualties, personnel count, live video from one or more cameras, time-shifted video, information on known weapons (for example, type of gun, caliber, number of rounds left before reloading), number of shots fired (detected through audio detection and analysis at monitored or monitoring station), etc. The first responders may also have a menu available on their display device to enable them to select, highlight, request and zoom into one or more of the details available in the enhanced information feed. Live video/audio feed, such as from body cameras worn by the first responders, can be uploaded to the monitoring location 24 over the communications network for analysis and monitoring of the real-time, on-site, critical incident situation as it unfolds. This information can also be provided as part of the enhanced information feed sent to the other first responders.

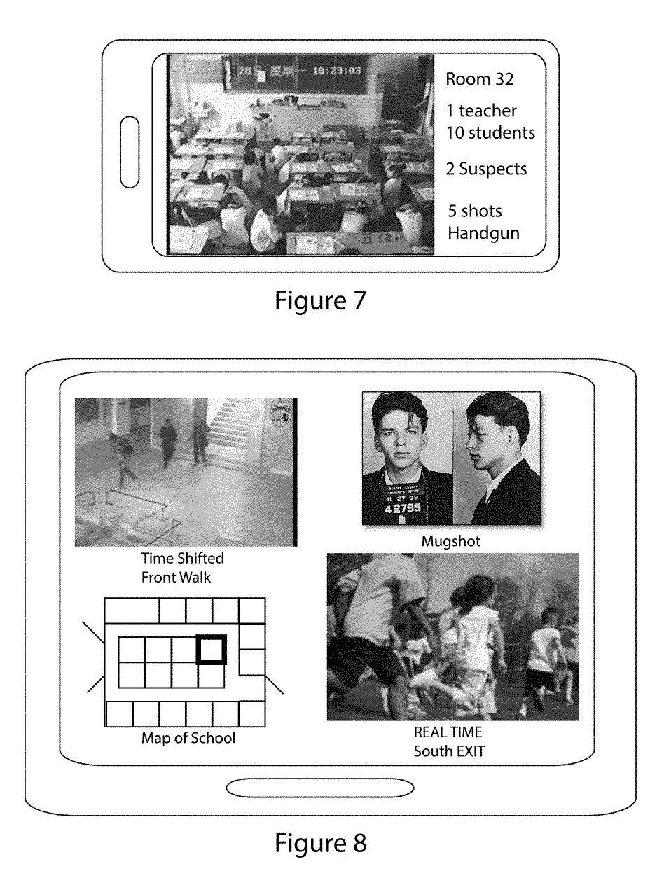

FIG. 7 illustrates a smartphone used by a responder display enhanced content related to a critical incident. FIG. 8 illustrates a laptop computer or pad display device displaying enhanced content related to a critical incident. The enhanced content is composed of enhancement data. The enhancement data may be, for example, generated from collected information. The collected information may be obtained from a variety of sources. For example, the enhanced content may be graphically displayed to the responder as a number of shots fired and, possibly with adequate sound analysis, for example, from a dedicated cloud-based server 40, an estimate of the type of weapon used to fire those shots (for example, handgun, shotgun or rifle). In this example, off-loading the data analysis to a dedicated server may be a more effective way for providing detailed analysis of sound (e.g., acoustic wave analysis for direction, number of shots and type of weapon) and images (e.g., facial recognition of intruder by using a criminal database). The number of shots and type of weapon may be provided as enhancement data generated from the computer analysis of sound signals from acoustic waves received by audio transducers and input to the microprocessor as collected sound information.

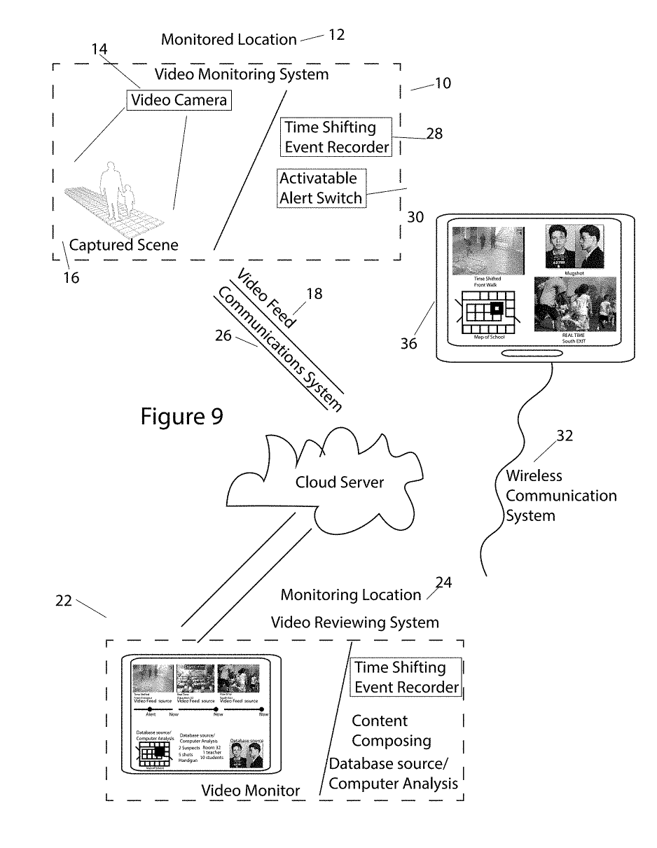

FIG. 9 is a schematic illustration showing components of another non-limiting, exemplary embodiment of the inventive critical incident system. A video capturing system 10 includes at least one video camera 14 located at a monitored location 12. At least some of the video cameras 14 may have extended storage capacity, which may be local or network based. For example, a camera trained on the front entry of a school may have a video time loop stored in a flash memory or other storage device. The video time loop enables rewinding of a scene, for example, to review suspects entering the school after the triggering of an alert alarm. The video cameras 14 capture a video scene 16 and generate a video feed 18 for display of the video scene 16. The video scene 16 includes images of a critical incident, for example, images at a school after an intruder has entered.

A video monitor 22 that includes at least one video monitor is located at a monitoring location. A communications system 26 transmits the video feed 18 from the video capturing system 10 to the video monitor 22. A content composing system, which may be located at the monitoring location or another location, composes enhanced content pertaining to the critical incident at least from the video feed 18. An activatable alert switch 30 causes the video capturing system 10 to remotely signal the video monitor 22 over the communications system 26 to indicate the occurrence of the critical incident. A wireless communications system 26 receives the composed enhanced content and transmits the enhanced content to at least one remote mobile display 36. The mobile display 36 displays the enhanced content to a responding personnel responding to the monitored location 12 in response to the occurrence of the critical incident.

The activatable alert switch 30 may comprise at least one of a user-activated panic button, a sound triggered transducer for triggering an alert in response to a detected noise having a predetermined characteristic, an acoustic signal analyzer for triggering the alert in response to an analyzed acoustic signal, and an image pattern analyzer for triggering the alert in response to an analyzed image pattern.

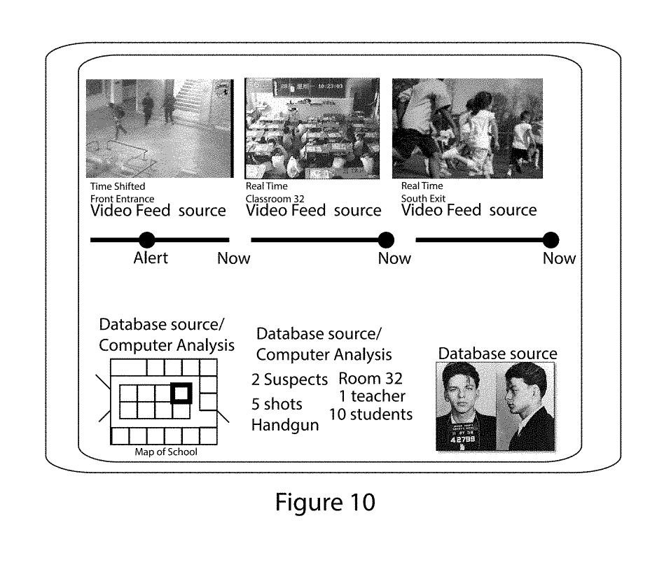

FIG. 10 illustrates video monitor displaying content available for composing an enhanced content display screen. A least one of the video capturing system 10 and the video monitor 22 may include a time shifting event recorder 28 for recording the video feed 18 from at least one video camera 14 for generating a time shifted version of the recorded video feed 18. In this case, the enhanced content may be composed to include or make use of the time shifted version of the recorded video feed 18.

The activable alert may cause the video capturing system 10 to remotely signal the video monitor 22 to obtain a map 34 of the monitored location 12 showing the location of the critical incident is displayed at the monitoring location. In this case, the enhanced content may include the map 34 of the monitored location 12.

The enhanced content may be composed of enhancement data generated from collected information obtained from a source. For example, computer code stored in memory and associated with a microprocessor may have instructions for implementing computer analysis of data obtained at the monitored location 12 or from another source such as a criminal data base. The various data available from various sources may be used to compose the enhanced content. For example, a pattern recognition system can be provided for analyzing at least one of an acoustic signal and a video image received from the video capturing system 10. In this case, the enhanced content is composed dependent on the analyzed acoustic signal or video image. The available data may comprise, for example at least one of video, audio, user inputted information, computer generated information, data retrieved from a database, etc., and the source may comprise, for example, at least one of a local data base, a network database, a cloud-based database, a video feed, an alert switch, an SMS message, a phone message, an email message, a computer analysis performed locally, remotely and/or at a cloud-based server location.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain, store, and/or transport the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A critical incident system, comprising: a video capturing system comprising at least one video camera located at a monitored location, each said at least one video camera capturing a video scene and generating a video feed for display of the video scene, wherein the video scene includes images of a critical incident; a video reviewing system comprising at least one video monitor located at a monitoring location; a communications system for transmitting the video feed from the video capturing system to the video reviewing system; a content composing system for composing enhanced content pertaining to the critical incident from the video feed; an activatable alert switch for causing the video capturing system to remotely signal the video reviewing system over the communications system to indicate the occurrence of the critical incident; a wireless communication system for transmitting the enhanced content; and at least one remote mobile display for receiving and displaying the enhanced content to a responding personnel responding to the monitored location in response to the occurrence of the critical incident.

2. A critical incident system according to claim 1, wherein at least one of the video capturing system and the video reviewing system includes a time shifting event recorder for recording the video feed from at least one of said at least one video camera for generating a time shifted version of the recorded video feed; and wherein the enhanced content includes the time shifted version of the recorded video feed.

3. A critical incident system according to claim 1, wherein the activatable alert switch comprises at least one of a user-activated panic button, a sound triggered transducer for triggering an alert in response to a detected noise having a predetermined characteristic, an acoustic signal analyzer for triggering the alert in response to an analyzed acoustic signal, and an image pattern analyzer for triggering the alert in response to an analyzed image pattern.

4. A critical incident system according to claim 1, wherein when the activatable alert causes the video capturing system to remotely signal the video reviewing system to obtain a map of the monitored location showing the location of the critical incident is displayed at the monitoring location; and wherein the enhanced content includes the map of the monitored location.

5. A critical incident system according to claim 4, further comprising a pattern recognition system for analyzing at least one of an acoustic signal and a video image received from the video capturing system; and wherein the enhanced content is composed dependent on the analyzed acoustic signal or video image.

6. A critical incident system according to claim 1, wherein the enhanced content is composed of available data obtained from a source.

7. A critical incident system according to claim 6, wherein the available data comprises at least one of video, audio, user inputted information, computer generated information, data retrieved from a database; and the source comprises at least one of a local data base, a network database, a cloud-based database, a video feed, an alert switch, an SMS message, a phone message, an email message, a computer analysis performed locally, remotely and/or at a cloud-based server location.

8. A method, comprising: capturing a video scene and generating a video feed containing the video feed using a video capturing system comprising at least one video camera located at a monitored location, each said at least one video camera capturing the video scene and generating the video feed for display of the video scene, wherein the video scene includes images of a critical incident; transmitting the video feed to a video reviewing system comprising at least one video monitor located at a monitoring location, wherein the video feed is transmitted over a communications system for transmitting the video feed from the video capturing system to the video reviewing system; receiving an alert from an activatable alert switch for causing the video capturing system to remotely signal the video reviewing system over the communications system to indicate the occurrence of the critical incident; composing enhanced content pertaining to the critical incident from the video feed; and wirelessly transmit the enhanced content pertaining to the critical incident to at least one remote mobile display for receiving and displaying the enhanced content to a responding personnel responding to the monitored location in response to the occurrence of the critical incident.

9. A critical incident system according to claim 8, wherein at least one of the video capturing system and the video reviewing system includes a time shifting event recorder for recording the video feed from at least one of said at least one video camera for generating a time shifted version of the recorded video feed; and wherein the enhanced content includes the time shifted version of the recorded video feed.

10. A critical incident system according to claim 8, wherein the activatable alert switch comprises at least one of a user-activated panic button, a sound triggered transducer for triggering an alert in response to a detected noise having a predetermined characteristic, an acoustic signal analyzer for triggering the alert in response to an analyzed acoustic signal, and an image pattern analyzer for triggering the alert in response to an analyzed image pattern.

11. A critical incident system according to claim 8, wherein when the activatable alert causes the video capturing system to remotely signal the video reviewing system to obtain a map of the monitored location showing the location of the critical incident is displayed at the monitoring location; and wherein the enhanced content includes the map of the monitored location.

12. A critical incident system according to claim 11, further comprising a pattern recognition system for analyzing at least one of an acoustic signal and a video image received from the video capturing system; and wherein the enhanced content is composed dependent on the analyzed acoustic signal or video image.

13. A critical incident system according to claim 8, wherein the enhanced content is composed of available data obtained from a source.

14. A critical incident system according to claim 13, wherein the available data comprises at least one of video, audio, user inputted information, computer generated information, data retrieved from a database; and the source comprises at least one of a local data base, a network database, a cloud-based database, a video feed, an alert switch, an SMS message, an phone message, an email message, a computer analysis performed locally, remotely and/or at a cloud-based server location.

15. An apparatus, comprising:
one or more processors; and
one or more memories including computer program code,
the one or more memories and the computer program code configured, with the one or more processors, to cause the apparatus to perform at least the following:
capture a video scene and generate a video feed containing the video feed using a video capturing system comprising at least one video camera located at a monitored location, each said at least one video camera capturing the video scene and generating the video feed for display of the video scene, wherein the video scene includes images of a critical incident; transmit the video feed to a video reviewing system comprising at least one video monitor located at a monitoring location, wherein the video feed is transmitted over a communications system for transmitting the video feed from the video capturing system to the video reviewing system; receiving an alert from an activatable alert switch for causing the video capturing system to remotely signal the video reviewing system over the communications system to indicate the occurrence of the critical incident; wherein the video feed is used to compose enhanced content pertaining to the critical incident from the video feed, and where the enhanced content pertaining to the critical incident is wirelessly transmitted from at least one of the monitored location and the monitoring location to at least one remote mobile display for receiving and displaying the enhanced content to a responding personnel responding to the monitored location in response to the occurrence of the critical incident.

16. A critical incident system according to claim 15, wherein at least one of the video capturing system and the video reviewing system includes a time shifting event recorder for recording the video feed from at least one of said at least one video camera for generating a time shifted version of the recorded video feed; and wherein the enhanced content includes the time shifted version of the recorded video feed.

17. A critical incident system according to claim 15, wherein the activatable alert switch comprises at least one of a user-activated panic button, a sound triggered transducer for triggering an alert in response to a detected noise having a predetermined characteristic, an acoustic signal analyzer for triggering the alert in response to an analyzed acoustic signal, and an image pattern analyzer for triggering the alert in response to an analyzed image pattern.

18. A critical incident system according to claim 15, wherein when the activatable alert causes remotely signal the monitoring location to obtain a map of the monitored location showing the location of the critical incident displayed at the monitoring location; and wherein the enhanced content includes the map of the monitored location.

19. A critical incident system according to claim 15, further comprising analyzing at least one of an acoustic signal and a video image received from the video capturing system; and wherein the enhanced content is composed dependent on the analyzed acoustic signal or video image.

20. A critical incident system according to claim 15, wherein the enhanced content is composed of available data obtained from a source, wherein the available data comprises at least one of video, audio, user inputted information, computer generated information, data retrieved from a database; and the source comprises at least one of a local data base, a network database, a cloud-based database, a video feed, an alert switch, an SMS message, an phone message, an email message, a computer analysis performed locally, remotely and/or at a cloud-based server location.
